(19) United States
(12) Patent Application Publication
(10) Pub. No.: US 2007/0293243 A1
(43) Pub. Date: Dec. 20, 2007

(54) Flexible A-GPS locator

(76) Inventors: Youyuh Shyr, San Jose, CA (US); Gary Gourjang Wu, Fremont, CA (US); Cheng Li, ChengDu (CN)

Correspondence Address: MURABITO, HAO & BARNES, LLP, TWO NORTH MARKET STREET, THIRD FLOOR, SAN JOSE, CA, 95113, US

(21) Appl. No.: 11/400,437

(22) Filed: Apr. 6, 2006

Related U.S. Application Data
(60) Provisional application No. 60/670,917, filed on Apr. 13, 2005.

(51) Int. Cl. H04Q 7/20; G01S 5/14; G08B 1/08

(52) U.S. Cl. 455/456.2; 340/539.13; 342/357.06; 455/466

(57) ABSTRACT

A Global Positioning System (GPS) system comprises a tracking device, a base station, and a mobile station. The tracking device has a GPS receiver for receiving GPS signals from a plurality of GPS satellites and generating position information. The base station complies with Global System of Mobile communication (GSM) standard and communicates with the tracking device by means of a Short Message Service (SMS) signal. The mobile station receives the position information via the base station for showing the position of the tracking device.

### CROSS REFERENCE TO PROVISIONAL APPLICATION

This application claims priority to the co-pending provisional patent application Ser. No. 60/670,917, Attorney Docket Number O2-IP-0237P, entitled “Flexible A-GPS Locator,” with filing date Apr. 13, 2005, and assigned to the assignee of the present invention, which is herein incorporated by reference in its entirety.

### TECHNICAL FIELD

This invention relates to a global positioning system, and more particularly to a global positioning system using a Short Message Service (SMS) tunnel to send and receive position information and GPS assistance data.

### BACKGROUND ART

The use of the Global Positioning System (GPS) satellite constellation for obtaining a terrestrial position fix (latitude and longitude) is widespread and well known. It has been proposed that mobile terminals (such as, but not limited to, cellular telephones, personal digital assistants, etc.) in modern wireless telecommunications systems include a capability to receive GPS signals and calculate position on the surface of the Earth.

In order to improve the performance of position calculation for mobile devices, a mobile terminal can have, in addition to GPS receiver capability, access to so-called GPS Assistance Data. The GPS Assistance Data is the same for all GPS capable mobile terminals within a given location area. The GPS assistance data is broadcasted (i.e., point-to-multipoint) to all GPS-capable mobile terminals within the location area. The GPS Assistance Data is composed of a large amount of data (about 500 bits/satellite) that is required to be delivered from the network side of the wireless telecommunications system to the GPS-capable mobile terminals. The GPS Assistance Data includes, in part, the following elements: number of satellites, reference time, reference location (the serving Base Transceiver Station [BTS] location), satellite ID, ephemeris, clock corrections, etc., and optional differential GPS [DGPS] corrections).

However, in current wireless telecommunication protocols, such as the one known as the Global System for Mobile Communications (GSM), the capacity of the point-to-multipoint broadcast channels (e.g., broadcast control channel [BCCH], short message service cell broadcast [SMS-CB], etc.) is limited. As such, it would be difficult or impossible in a practical sense to fit the required GPS assistance data into the currently defined point-to-multipoint broadcast channels.

Moreover, in some situations, the Code Division Multiple Access (CDMA) and General Packet Radio Service (GPRS) are used to transmit the GPS assistance data from the network side of the wireless telecommunications system to the GPS-capable mobile terminals. However, these approaches need expensive infrastructure as well as high user charges.

### SUMMARY OF THE INVENTION

It is an object of the present invention to provide a GPS system using SMS for transmitting position information.

In order to achieve the above object, the present invention provides a GPS system comprising a tracking device, a base station, and a mobile station. The tracking device has a GPS receiver for receiving GPS signals from a plurality of GPS satellites that is used for generating position information. The base station complies with GSM standard and communicates with the tracking device by means of a SMS signal. The mobile station receives the position information via the base station for showing the position of the tracking device.

### BRIEF DESCRIPTION OF THE DRAWINGS

Other objects, advantages, and novel features of the invention will become more apparent from the following detailed description when taken in conjunction with the accompanying drawing.

FIG. 1 is a block diagram showing a global positioning system according to an embodiment of the present invention.

FIG. 2 is a block diagram showing another global positioning system according to an embodiment of the present invention.

FIG. 3 is a block diagram showing a method for position a tracking device according to an embodiment of the present invention.

### DESCRIPTION OF THE EMBODIMENT

Reference will now be made in detail to the embodiments of the present invention, flexible A-GPS locator. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Some embodiments of the present invention communicate using SMS signals. SMS is a mechanism of delivery of short messages (also known as text messages) over the mobile networks, such as mobile phone or personal digital assistant (PDA). The text message from the sending mobile device is stored in a central short message center which then forwards it to the destination mobile device.

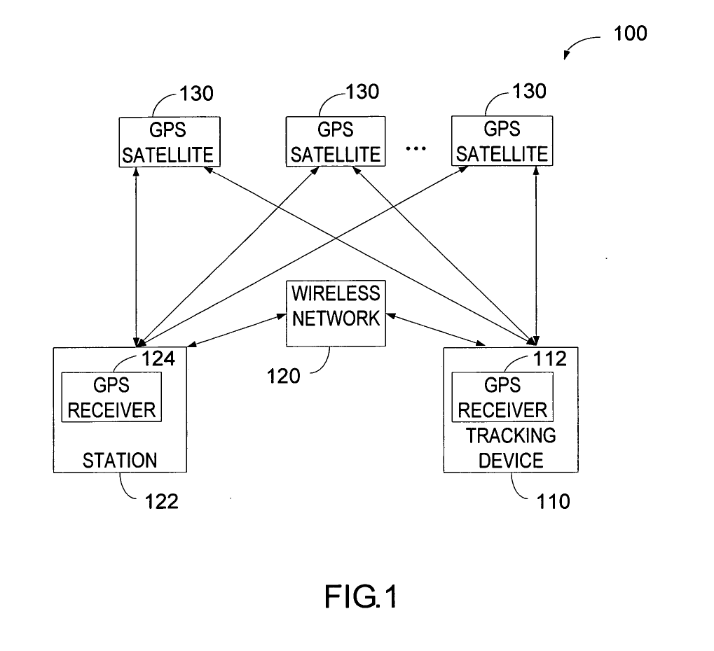

Referring to FIG. 1, a GPS system 100 according to an embodiment of the present invention is illustrated. The GPS system 100 includes a tracking device 110, a wireless network 120 (e.g., a base station), a wireless station 122 and a plurality of GPS satellites 130 for transmitting GPS signals. The GPS system 100 shown in FIG. 1 is a point-to-point mode GPS system, in accordance with one embodiment of the present invention. In this mode, the tracking device 110 directly communicates with the wireless station 122 through the wireless network 120 thereby allowing the position of the tracking device 110 to be monitored.

The tracking device 110 or a locator on the tracking device 110 has a GPS receiver 112 for receiving the GPS signals from a plurality of GPS satellites 130. In general, locking on to the signals from at least three orbiting GPS satellites provides the capability to accurately calculate a position (latitude and longitude) of an associated tracking device 110. In addition, the movement of the tracking device 110 can also be tracked using signals from the orbiting GPS satellites 130.

In embodiments of the present invention, the wireless station 122 can be any mobile device, such as a mobile phone, a PDA, a notebook computer with wireless connection, etc. That is, the station 122 is a mobile, wireless station. In other embodiments, the station 122 is any stationary device, such as a desktop computer. In that case, the station 122 is a fixed, wireless station.

In one embodiment, the wireless network 120 is a GSM network which may comprise a plurality of base station subsystems (BSS) each including a plurality of base stations (BS) or base transceiver stations (BTS), and a plurality of base station controllers (BSC). The base subsystems may be coupled to a network and switching subsystem (NSS) for the handoff of data communications from one BSS to another. In accordance with one embodiment of the present invention, the station 122 communicates with the tracking device 110 through the GSM network.

In accordance with one embodiment of the present invention, the tracking device 110 is installed in a moving vehicle (not shown). As an example, the wireless station 122 is used by a user to monitor the position of the vehicle by monitoring the position of the tracking device 110.

The GPS receiver 112 of the tracking device 110 receives GPS signals from the plurality of GPS satellites 130 to calculate GPS information (e.g., position or movement) related to the tracking device 110. Then, the GPS information, such as latitude and longitude, is sent to the station 122 via the wireless network 120 (e.g., through a base station) by means of a short message signal, in one embodiment of the present invention. The short message substantially complies with the SMS communications protocol and its derivatives. As described hereinabove, the SMS was created for use in GSM digital wireless networks, but can be used in any digital wireless service for the purpose of transmitting short messages between wireless devices, in according to embodiments of the present invention. In other words, it is not necessary to provide an additional mobile network support, such as GPRS or CDMA, as is required in conventional tracking systems. As such, the tracking device 110 can be incorporated into any type of cellular phone (e.g., GSM supported), for example. The benefits are reduced cost, immediate integration with present communication systems, etc.

In one embodiment, the GPS information (e.g., position, movement, altitude, etc) related to the tracking device 110 is sent in response to a request from the station 122, or another electronic device. In another embodiment, the GPS information related to the tracking device is sent periodically to the station 122.

According to another embodiment of the present invention, the tracking device 110 is able to receive GPS assistance data to increase accuracy of the GPS information (e.g., position, movement) related to the tracking device 110. As such, the tracking device 110 is an assisted GPS (A-GPS) device.

In this embodiment, the wireless station 122 has a GPS receiver 124 for receiving GPS signals from the GPS satellites 130 and is able to access GPS assistance data. The GPS assistance data for the wireless station 122 is sent to the tracking device 110 via the wireless network 120 by means of a short message signal. In embodiments of the present invention, the station 122 is able to determine which GPS assistance data is relevant to the geographic area in which the tracking station 110 is located. As such, the station 122 is able to send the most relevant GPS assistance data to the tracking station 110.

As described hereinabove, conventionally the GPS assistance data is transmitted through CDMA or GPRA technology, which needs additional expensive infrastructure to be deliverable to the tracking device 110. In addition, an additional charge may be levied for sending this assistance GPS data to the tracking station 110. However, in the present embodiment, since the GPS assistance data is sent to the tracking device 110 from the wireless station 122 by means of a short message signal, it is not necessary to provide an additional mobile network support, such as GPRS or CDMA, when sending GPS information to the tracking station 110. Further, it will be apparent to those skilled in the art that, in other embodiments, an SMS signal with GPS assistance data complies with the 3GPP specification (Third Generation Partnership Project), or in another embodiment is sent through CDMA technology.

As described hereinbefore, the wireless station 122 monitors the position of the tracking device 110 by the short message signal. In one embodiment of the present invention, the tracking device 110 is useful for lost-finder products, such as a child locator, a vehicle locator for vehicle stolen prevention, or other theft-proof system. For example, the tracking device 100 can be installed in a car. As such, the car owner can easily find where the vehicle is, even if the car is stolen.

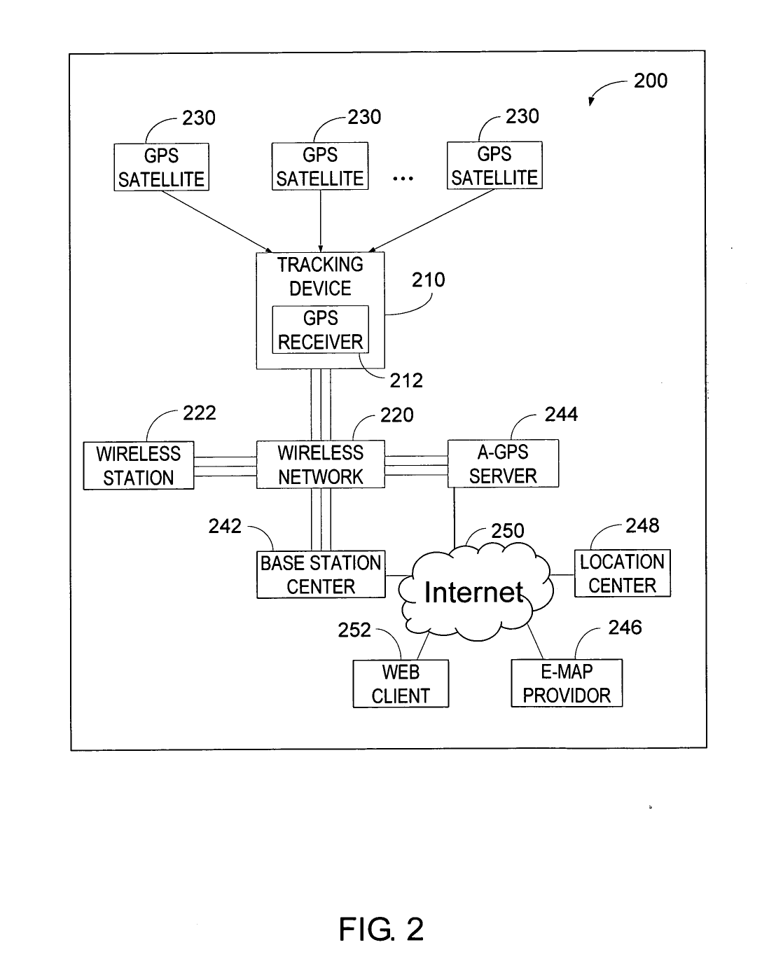

Referring to FIG. 2, a GPS system 200 according to another embodiment of the present invention is illustrated. In contrast to the GPS system 100 shown in FIG. 1 which is a point-to-point mode GPS system, the GPS system 200 shown in FIG. 2 is a network service mode GPS system. In the network service mode, a web-client (e.g., web client 252) is used to monitor the position of a tracking device 210. The GPS system 200 includes the tracking device 210 having a GPS receiver 212 for receiving GPS signals from a network of GPS satellites 230. The tracking device 210 also communicates directly with an A-GPS server 244 so as to obtain GPS assistance data for accurately positioning the tracking device 210. For example, in one embodiment, the tracking device 210 communicates with the A-GPS server 244 through the wireless network 220.

In one embodiment, the tracking device 210 receives the GPS assistance data through a short message tunnel via a wireless network 220. That is, the A-GPS server 244 is able to send GPS assistance data to the tracking device 210 by means of a short message (e.g., SMS signal). The wireless network 220 may be a GSM network which may comprise a plurality of base station subsystems (BSS) each including a base station center (BSC) and a plurality of base stations (BS) or base transceiver stations (BTS). The base subsystems may be coupled to a network and switching subsystem (NSS) for the handoff of data communications from one BSS to another. In accordance with one embodiment of the present invention, the wireless station 222 and the web client 252 communicate with the tracking device 110 through a GSM system.

The position information of the tracking device 210, as calculated by the tracking device 210, is sent or transmitted to a base station center 242 through an SMS signal using the wireless network 220. In accordance with one embodiment of the present invention, the received position information of the tracking device 210 is then sent or transmitted from the base station center to a wireless station 222, such as a mobile phone, via the wireless network 220 by means of an SMS signal.

In accordance with other embodiments of the present invention, the received position information of the tracking device 210 is sent or transmitted to a wireless station 222 via some other digital tunnel, such as GPRS or CDMA signals.

Alternatively, the received position information of the tracking device 210 is sent or transmitted by the base station center 242 to a location center 248, or web client 252, via Internet 250 through TCP/IP (Transmission Control Protocol/Internet Protocol) protocols, in accordance with one embodiment of the present invention. Either of the location center 248 or web client 252 can be used for monitoring and responding to the tracking device 210. That is, instead of the wireless station 222, the location center 248 or the web client 252 is used to monitor the tracking device 210.

In particular, a user uses the web client 252 (e.g., through a terminal at web client 252) to communicate with the location center 248 via the Internet 250 through TCP/IP protocols, in accordance with one embodiment of the present invention. The location center 248 sends the GPS information back to the web client via the Internet 250. That is, instead of communicating through a wireless station 222, a user can utilize the features of a web client 252 to obtain GPS information for the tracking device 210.

In accordance with another embodiment of the present invention, an electronic-map (E-map) provider 246 also communicates with the A-GPS server 244 (e.g., directly through a communication network, or through the Internet 250, etc.) to obtain GPS assistance data for the geographic location where the tracking device 210 is generally located.

In particular, the E-map provider 246 is communicatively coupled with the location center 248. As such, the location center 248 can provide GPS information related to the tracking device 210 to the E-map provider 246 via the Internet 250. The E-map provider 246 is able to integrate the GPS information, and GPS assistance data if necessary, into an E-map. In another embodiment, the E-map provider 246 sends to the location center 248 an E-map that also integrates the position of the tracking device 210. As such, the location center 248 is able to communicate with the wireless station 222 or the web client 252 to provide the E-map with the GPS information related to the tracking device 210.

In one embodiment, the position of the tracking device 210 can be shown on the E-map. The user can monitor the position of the tracking device 210 on the E-map by means of the web client 252 or the wireless station 222. As such, the user has visual information indicating the geographic position of the tracking device 210 overlaid on an E-map.

In accordance with another embodiment of the present invention, the GPS system 200 includes a plurality of tracking devices. Each of the plurality of tracking devices 210 has a unique identification number. As such, the unique identification number is sent along with the GPS information for a particular tracking device (e.g., device 210) to associate the GPS information with the correct tracking device. In this way, each of the plurality of tracking devices 210 can be individually tracked using available GPS information.

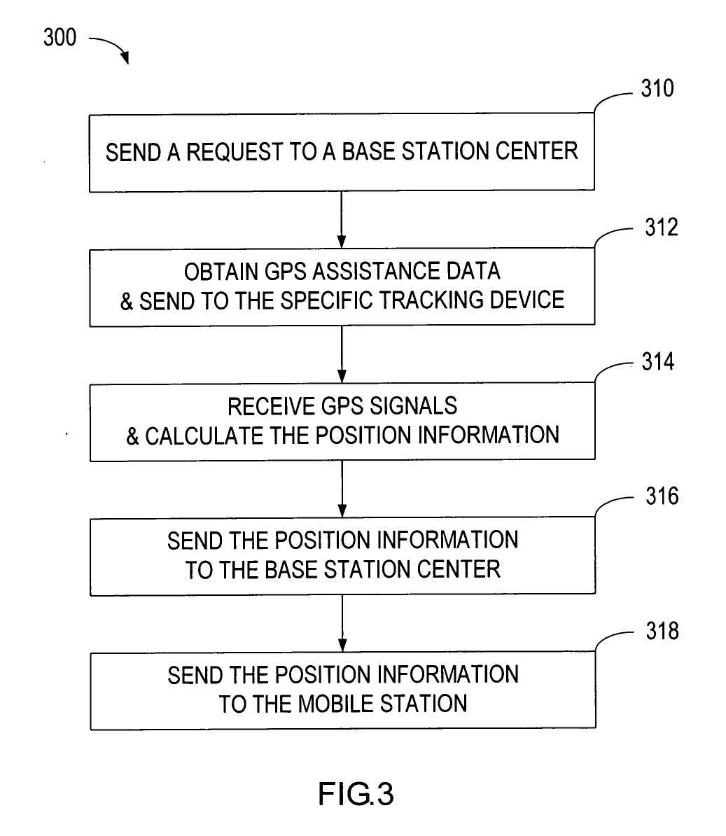

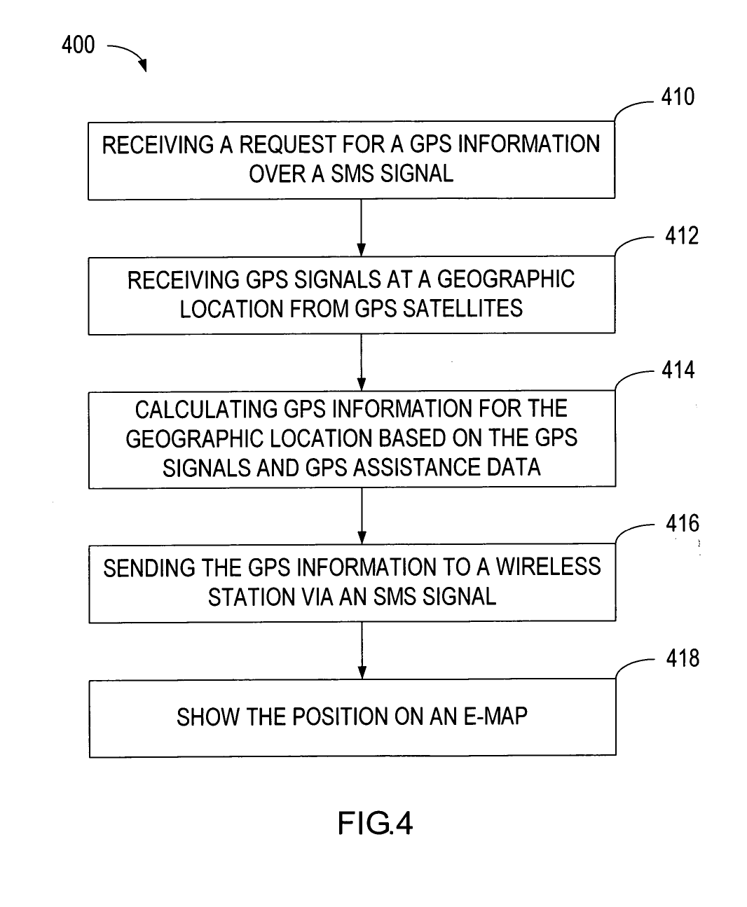

Referring to FIG. 3, a method 300 for providing GPS information related to a tracking device according to an embodiment of the present invention is illustrated. As shown in FIG. 3, at 310, a user uses a wireless station (e.g., cellular phone) to send a request for the position of a tracking device. The tracking device is associated with a unique identification number. In one embodiment, the user sends the request including the unique identification number to a base station center via a wireless network. The base station center processes the request.

At 312, the base station center communicates with an A-GPS server for obtaining GPS assistance data and sends the GPS assistance data to the specific tracking device associated with the unique identification. The A-GPS server can transmit the GPS assistance date to the base station center through a wireless network, or a telecommunication system, such as a GSM system. Alternatively, the A-GPS server can transmit the GPS assistance date to the base station center through the Internet. The GPS assistance data can be transmitted from the base station center to the specific tracking device via an SMS signal through a wireless network.

At 314, the tracking device receives GPS signals from the GPS satellites, and then calculates its position information. It will be apparent to those skilled in the art that the received GPS signal includes the pseudo-random code and ephemeris from the GPS satellite. In one embodiment, the position information is calculated using the GPS signals from the GPS satellites in conjunction with the received GPS assistance data.

At 316, the specific tracking device 210 sends the calculated position information to the base station center through an SMS signal.

At 318, the position information associated with the specific tracking device then is sent or transmitted to the wireless station through an SMS signal. Alternatively, the position can be sent to the wireless station through other signals, such as GPRS or CDMA signals according to other embodiments of the present invention, if necessary. Furthermore, for easily reading the position information, an e-map can be showed on the screen of the wireless station and the position of the tracking device is shown on the e-map. The e-map can be obtained from an e-map provider through TCP/IP protocols, and then sent to the wireless station through an SMS signal or GPRS/CDMA signal.

Alternatively, in accordance with another embodiment of the present invention, the e-map is stored in the wireless station. As the wireless station obtains the position information of the tracking device, the position of the tracking device will be shown on the e-map.

In another operation mode according to another embodiment of the present invention, a user can use a web client or web terminal to monitor the position of a tracking device. That is, instead of a wireless station, a web client is used for purposes of monitoring a tracking device using GPS information, as outlined in the method of FIG. 3. In other words, at 310, the user uses the web client or web terminal to send a request associated with the unique identification number of the specific tracking device for the position of the specific tracking device. The request is transmitted to a base station center via a network, such as Internet 250, in one embodiment. Thereafter, the base station center is able to send the request to the specific tracking device.

Furthermore, at 312, the request with the GPS assistance data is sent to a specific tracking device through an SMS signal. At 314, the position of the specific tracking device is calculated from the GPS signal of the GPS satellites and the GPS assistance data. At 316, the calculated position information will be sent to the base station center through the SMS signal. For clarity, the same remaining steps are not described herein.

As described hereinabove, the architectures of the GPS systems according to the embodiments of the present invention support a low cost tracking service device and can be easily upgraded. The position information or data is compressed and re-encoded, and then can be sent or received through the existing SMS tunnel. It is not necessary to do any modification on the network structure.

Referring to FIG. 4, a method 400 for providing GPS information according to an embodiment of the present invention is illustrated. As shown in FIG. 4, at 410, a user uses a wireless station to send a request to a tracking device over an SMS signal for positioning the tracking device. As such, the request is received at the tracking device. The request includes an identifier to identify the tracking device. The SMS signal substantially complies with a GSM standard, and its derivatives, in one embodiment. In accordance with another embodiment of the present invention, the request also includes GPS assistance data from an A-GPS server.

At 412, in reply to the request, the tracking device accesses and receives GPS signals from a plurality of satellites at a geographic location. The GPS signal may be provided from one or more of the plurality of satellites. The GPS assistance data is also received by the tracking device.

At 414, GPS information for the geographic location can be calculated based on the GPS signals from the satellites and the GPS assistance information. According to embodiments of the present invention, the GPS information is calculated by the tracking device using one or both of the GPS signals and the GPS assistance information. Alternatively, the GPS assistance data can be sent to a location center, and the GPS signal from the satellites is also sent to the location center to be combined with the GPS assistance data to calculate the GPS information for the geographic location of the tracking device.

Furthermore, according to an embodiment of the present invention, the GPS information can be the position information associated with the geographic location of the tracking device. Alternatively, the GPS information can include motion information of the tracking device. The motion information of the tracking device can also be calculated by the tracking device or the location center. In still other embodiments, other information capable of being derived from either or both of GPS signals and GPS assistance data is associated with the tracking device as GPS information.

At 416, the GPS information is sent to a wireless station via another SMS signal. As mentioned hereinbefore, the SMS substantially complies with the GSM standard. Thus, it is not necessary to provide an additional mobile network support, such as GPRS or CDMA, thereby reducing additional infrastructure costs.

At 418, an E-map is provided corresponding to the geographic location of the tracking device, in accordance with one embodiment. The E-map can be provided by an E-map server, and sent to the location center or the wireless station by mean of the Internet or wireless network. The GPS information and the E-map are transmitted to the wireless station. The position of tracking device is shown on the E-map.

While the foregoing description and drawings represent the preferred embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A tracking device, comprising:
a receiver for receiving global positioning system (GPS) signals from a plurality of GPS satellites and generating GPS information associated with said tracking device based on said GPS signals; and
a transmitter coupled to said receiver for transmitting an SMS signal comprising said GPS information over a wireless network.

2. The tracking device of claim 1, wherein said receiver receives a request in a second SMS signal for said GPS information from a wireless station over said wireless network.

3. The tracking device of claim 2, wherein said receiver receives said second SMS signal further comprising GPS assistance data related to said tracking device.

4. The tracking device of claim 2, wherein said receiver receives said second SMS signal from a base station center coupled to said tracking device and said wireless station through said wireless network, and wherein said base station center receives said SMS signal from said tracking device and sends said SMS signal to said wireless station.

5. The tracking device of claim 1, wherein said SMS signal is sent using a GSM format over said wireless network.

6. The tracking device of claim 1, further comprising:
a unique identification number for identifying said tracking device when communicating said SMS signal.

7. A Global Positioning System (GPS) system, comprising:
a wireless network for communication;
a tracking device having a GPS receiver for receiving GPS signals from at least one of a plurality of GPS satellites and generating GPS information associated with said tracking device based on said at least one of a plurality of GPS signals; and
a wireless station for accessing GPS assistance data related to said tracking device, wherein said wireless station provides said GPS assistance data to said tracking device in an SMS signal over said wireless network such that said tracking device utilizes said GPS assistance data when generating said GPS information.

8. The GPS system of claim 7, wherein said wireless station is a mobile station.

9. The GPS system of claim 7, wherein said wireless station further comprises:
a second GPS receiver for receiving said GPS assistant data associated with said tracking device from said plurality of GPS satellites, wherein said wireless station is capable of sending said GPS assistance data to said tracking station using a second SMS signal via said wireless network.

10. The GPS system of claim 7, wherein said GPS information comprises position information.

11. The GPS system of claim 7, wherein said GPS information comprises motion information of said tracking device.

12. The GPS system of claim 7, further comprising:
an assisted GPS server for providing said GPS assistance data to said wireless station for facilitating positioning of said tracking device.

13. The GPS system of claim 7, further comprising:
an e-map provider for providing an e-map to said wireless station for showing a position of said tracking device on said e-map.

14. The GPS system of claim 7, further comprising:
a base station center communicating with said tracking device and said wireless station by means of said SMS signal over said wireless network.

15. A method for providing global positioning satellite (GPS) information, comprising:
receiving GPS signals corresponding to a geographic location from at least one of a plurality of GPS satellites;
accessing GPS assistance data corresponding to said geographic location;
calculating GPS information for said geographic location based on said GPS signals and said GPS assistance data; and
sending said GPS information to a wireless station via an SMS signal.

16. The method of claim 15, further comprising:
receiving a request for said GPS information from said wireless station over a second SMS signal, wherein said request comprises said GPS assistance data.

17. The method of claim 15, wherein said receiving GPS signals further comprises:
receiving said GPS signals at a tracking device.

18. The method of claim 17, wherein said receiving said request further comprises:
receiving an identifier with said request, wherein said identifier identifies said tracking device.

19. The method of claim 15, wherein said sending said GPS information further comprises:
sending said SMS signal substantially complying with a GSM standard.

20. The method of claim 17, wherein said calculating GPS information further comprises:
calculating position information associated with said geographic location of said tracking device.

21. The method of claim 17, wherein said calculating GPS information further comprises:
calculating motion information associated with said tracking device.

22. The method of claim 15, further comprising:
receiving an e-map corresponding to said geographic location of said tracking device; and
providing said GPS information on said e-map.
